(19) United States
(12) Patent Application Publication
(10) Pub. No.: US 2025/0063528 A1
(43) Pub. Date: Feb. 20, 2025

(54) METHODS AND APPARATUS FOR PERFORMING NETWORK SLICE RESELECTION

(71) Applicant: SAMSUNG ELECTRONICS CO., LTD., Suwon-si (KR)

(72) Inventors: Jagadeesh GANDIKOTA, Bangalore (IN); Koustav ROY, Bangalore (IN); Danish Ehsan HASHMI, Bangalore (IN); Arijit SEN, Bangalore (IN); Jyotirmoy KARJEE, Bangalore (IN); Lalith KUMAR, Bangalore (IN)

(21) Appl. No.: 18/753,521

(22) Filed: Jun. 25, 2024

Related U.S. Application Data
(63) Continuation of application No. PCT/KR2024/007886, filed on Jun. 10, 2024.

(30) Foreign Application Priority Data
Aug. 17, 2023 (IN) 202341055290

(51) Int. Cl. H04W 60/04; H04W 40/22; H04W 48/18; H04W 84/04

(52) U.S. Cl. CPC H04W 60/04; H04W 40/22; H04W 48/18; H04W 84/042

(57) ABSTRACT

According to an example embodiment of the disclosure, a method for performing network slice reselection by a User Equipment (UE) is disclosed. The method comprises identifying allowed network slices within a first Network Slice Simultaneous Registration Group (NSSRG) for first applications at the UE. The method comprises receiving an initialization request from a second application at the UE. The method comprises determining one or more UE Route Selection Policy (URSP) rules for the second application. The method comprises determining whether the network slice required for the second application corresponds to one of the one or more allowed network slices within the first NSSRG. The method comprises transmitting, to a network, a second registration request for registration of the UE to a second NSSRG including the network slice required for the second application based on the URSP rules for the second application.

### CROSS-REFERENCE TO RELATED APPLICATIONS

This application is a continuation of International Application No. PCT/KR2024/007886 designating the United States, filed on Jun. 10, 2024, in the Korean Intellectual Property Receiving Office and claiming priority to Indian Patent Application No. 202341055290, filed on Aug. 17, 2023, in the Indian Patent Office, the disclosures of each of which are incorporated by reference herein in their entireties.

### BACKGROUND

### Field

The disclosure relates to communication networks, and for example, to systems and methods for registering a user equipment (UE) to a network slice supported by a communication network.

### Description of Related Art

A network slice is an independent network instance within a communication network infrastructure that is tailored to meet specific requirements of a particular service or application. Each network slice can have its own set of characteristics, such as specific quality of service (QoS) parameters, latency, throughput, security, and resource allocations. Further, a network slice simultaneous registration Group (NSSRG) refers to a feature that allows a UE to simultaneously register with multiple network slices within the communication network (e.g., 5G network). Thus, the NSSRG feature enables the UE to establish connections with multiple network slices concurrently. This capability may be particularly useful when the UE requires different network resources and services simultaneously. For example, the UE may be registered to one network slice for low-latency applications, while being connected to another network slice for high-bandwidth services, thereby enhancing the flexibility and efficiency of the communication networks.

When a user equipment (UE) needs to access network slices that are available on various frequency bands, the UE may need to select a frequency band and connect to a network, disconnect/disable a connection, or switch between different frequency bands.

Thus, to access the network slices, the UE may receive, from the network, an allowed network slice selection assistance information (NSSAI) for each single network slice selection assistance information (S-NSSAI), which the network configures as a part of UE access and mobility subscription, during a UE registration procedure. Accordingly, the subscription information for the UE may include, for each S-NSSAI, network slice simultaneous registration group (NSSRG) information constraining which S-NSSAIs can be simultaneously provided to the UE in the allowed NSSAI. Two S-NSSAIs sharing at least one NSSRG can be simultaneously included in the allowed NSSAI. Otherwise, these S-NSSAIs cannot be included simultaneously in the allowed NSSAI. The NSSRG information, defining the association of S-NSSAIs to NSSRG, is provided as additional and separate information.

When a supporting access management function (AMF) in 5G network architecture receives a requested NSSAI, the AMF evaluates the S-NSSAIs of the home public land mobile network (HPLMN) (in the mapping information of the requested NSSAI, when mapping information is applicable) based on any received NSSRG information for these S-NSSAIs, to determine whether the S-NSSAIs can be provided together in the allowed NSSAI.

The UE may support the subscription-based restrictions for simultaneous registration of the network slice feature. In this case, the UE may indicate its support in the registration request message in the initial registration and the mobility registration update. The supporting AMF stores, in the UE context, whether the UE has indicated support for the feature.

The UE which receives the NSSRG values in the network slicing configuration information shall only include in the requested NSSAI, S-NSSAIs that share a common NSSRG as per the received information. If the HPLMN changes NSSRG information in the subscription information for a UE, the unified data management (UDM) updates the supporting AMF serving the UE with the new NSSRG information and the AMF updates the UE as necessary with network slicing configuration by means of the UE configuration update procedure.

As the UE can include only slices belonging to the same group, there will be instances where UE cannot access other slices belonging to different NSSRG groups and uses default network slices which may degrade UE's experience. Or there can be cases where the UE can send frequent requests to change the requested NSSAI and hence allowing the network to provide a new allowed NSSAI list.

Accordingly, there is a need to address the above-mentioned shortcomings associated with inaccessibility to network slices belonging to different NSSRG groups.

### SUMMARY

According to an example embodiment of the disclosure, a method for performing network slice reselection by a user equipment (UE) is disclosed. The method comprises identifying one or more allowed network slices within a first network slice simultaneous registration group (NSSRG) for one or more first applications at the UE. Further, the method comprises receiving an initialization request from a second application at the UE. Further, the method comprises determining one or more UE route selection policy (URSP) rules for the second application based on the received initialization request, the one or more URSP rules indicating at least one of a network slice required for the second application. The method further comprises determining whether the network slice required for the second application corresponds to one of the one or more allowed network slices within the first NSSRG. The method further comprises transmitting, to a network, a second registration request for registration of the UE to a second NSSRG including the network slice required for the second application based on the URSP rules for the second application, based on determining that the network slice required for the application does not correspond to the one or more allowed network slices.

According to an example embodiment of the disclosure, a method for performing network slice reselection by a user equipment (UE) is disclosed. The method comprises identifying one or more allowed network slices within a first network slice simultaneous registration group (NSSRG) for one or more first applications at the UE. Further, the method comprises receiving an initialization request from a second application at the UE. Further, the method comprises determining one or more UE route selection policy (URSP) rules for the second application based on the received initialization request, the one or more URSP rules indicating at least one of a network slice required for the second application. The method further comprises determining whether the network slice required for the second application corresponds to one of the one or more allowed network slices within the first NSSRG. The method further comprises based on determining that the network slice required for the application does not correspond to the one or more allowed network slices: identifying a weight corresponding to each of the second application and the one or more first applications; comparing the weight of the second application with the weight corresponding to each of the one or more first applications; and transmitting, to a network, a second registration request for registration of the UE to a second NSSRG including the network slice required for the second application based on determining that the weight of the second application is greater than the weight corresponding to each of the one or more first applications.

According to an example embodiment of the disclosure, a system for performing network slice reselection at a user equipment (UE) is disclosed. The system comprises: a memory, and at least one processor, comprising processing circuitry, communicably coupled to the memory. At least one processor is configured to identify one or more allowed network slices within a first network slice simultaneous registration group (NSSRG) for one or more first applications at the UE. Further, at least one processor is configured to receive an initialization request from a second application at the UE. Further, at least one processor is configured to determine one or more UE route selection policy (URSP) rules for the second application based on the received initialization request, the one or more URSP rules indicating at least one of a network slice required for the second application. Further, at least one processor is configured to determine whether the network slice required for the second application corresponds to one of the one or more allowed network slices within the first NSSRG. Further, at least one processor is configured control the system to transmit, to a network, a second registration request for registration of the UE to a second NSSRG including the network slice required for the second application based on the URSP rules for the second application, based on determining that the network slice required for the application does not correspond to the one or more allowed network slices.

According to an example embodiment of the disclosure, a system for performing network slice reselection at a user equipment (UE) is disclosed. The system comprises: a memory, and at least one processor, comprising processing circuitry, communicably coupled to the memory. At least one processor is configured to identify one or more allowed network slices within a first network slice simultaneous registration group (NSSRG) for one or more first applications at the UE. Further, at least one processor is configured to receive an initialization request from a second application at the UE. Further, at least one processor is configured to determine one or more UE route selection policy (URSP) rules for the second application based on the received initialization request, the one or more URSP rules indicating at least one of a network slice required for the second application. Further, at least one processor is configured to determine whether the network slice required for the second application corresponds to one of the one or more allowed network slices within the first NSSRG. Further, at least one processor is configured to based on determining that the network slice required for the application does not correspond to the one or more allowed network slices: identify a weight corresponding to each of the second application and the one or more first applications; compare the weight of the second application with the weight corresponding to each of the one or more first applications; and control the system to transmit, to a network, a second registration request for registration of the UE to a second NSSRG including the network slice required for the second application based on determining that the weight of the second application is greater than the weightcorresponding to each of the one or more first applications.

To further describe the advantages and features of the disclosure, a more detailed description of various example embodiments illustrated in the appended drawings will be provided. It is appreciated that the drawings depict various example embodiments of the disclosure and are not to be considered limiting of its scope. The disclosure will be described and explained in greater detail with reference to the accompanying drawings.

### BRIEF DESCRIPTION OF THE DRAWINGS

The above and other features, aspects, and advantages of certain embodiments of the disclosure will be more apparent from the following detailed description taken in conjunction with the accompanying drawings in which like characters represent like parts throughout the drawings, an in which:

FIG. 1 is a diagram illustrating a plurality of Network Slice Simultaneous Registration Group (NSSRG) groups for the initial registration of a user equipment (UE), according to a prior art technique;

FIG. 2 is a signal flow diagram illustrating a process flow depicting initial registration procedure when the UE does not have NSSRG information, according to a prior art technique;

FIG. 3 is a signal flow diagram illustrating a process flow depicting a first problem when the UE is unable to use a network slice belonging to different NSSRG groups, according to prior art;

FIG. 4 is a signal flow diagram illustrating an example process flow addressing the first problem illustrated in FIG. 3, by changing the NSSRG group by sending registration update request to include a new requested NSSAI list, according to various embodiments;

FIG. 5 is a block diagram illustrating a second problem associated with detection of Ultra-Reliable and Low-Latency Communications (URLLC) or Local Area Data Network (LADN) area and need for using a different NSSRG, according to a prior art technique;

FIG. 6 is a signal flow diagram illustrating a process flow depicting a second problem associated with the UE being unable to use URLLC/LADN services over different NSSRG, according to a prior art technique;

FIG. 7 is a signal flow diagram illustrating an example process flow addressing the second problem illustrated in FIGS. 5 and 6 by changing the NSSRG group by sending a registration update request to include new LADN NSSAI in the requested NSAAI list, according to various embodiments;

FIG. 8 is a signal flow diagram illustrating a process flow depicting a third problem associated with an allocation of same network slices for a UE 804 from two different access networks, according to a prior art technique;

FIG. 9 is a signal flow diagram illustrating an example process flow addressing the third problem illustrated in FIG. 8, by selecting slices belonging to different NSSRG groups when registering on two different network access, according to various embodiments;

FIG. 10 is a signal flow diagram illustrating a process flow depicting a fourth problem associated with allocation of same network slices from two different subscriptions, according to a prior art technique;

FIG. 11 is a signal flow diagram illustrating an example process flow addressing the fourth problem illustrated in FIG. 10, by selecting slices belonging to different NSSRG groups when registering on two different networks, according to an various embodiments;

FIG. 12 is a diagram illustrating a plurality of NSSRG groups for the initial registration of the UE, according to various embodiments;

FIG. 13 is a flowchart illustrating an example method for determining whether a change of NSSRG is required, according to various embodiments;

FIGS. 14A, 14B and 14C are flowcharts illustrating an example method for performing network slice reselection by a User Equipment (UE), according to various embodiments;

FIGS. 15A, 15B and 15C are flowcharts illustrating an example method for performing network slice reselection by the UE, according to various embodiments; and

FIG. 16 is a block diagram illustrating an example configuration of a user equipment (UE) in a wireless communication system, according to various embodiments.

Further, skilled artisans will appreciate that elements in the drawings are illustrated for simplicity and may not have necessarily been drawn to scale. For example, the flowcharts illustrate methods in terms of operations involved to help to improve understanding of aspects of the disclosure. Furthermore, in terms of the construction of the device, one or more components of the device may have been represented in the drawings by conventional symbols, and the drawings may show only those specific details that are pertinent to understanding the various example embodiments of the disclosure so as not to obscure the drawings with details that will be readily apparent to those of ordinary skill in the art having the benefit of the description herein.

### DETAILED DESCRIPTION

To aid in understanding principles of the disclosure, reference will now be made to the various example embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this disclosure to “an aspect”, “another aspect” or similar language may refer, for example, to a particular feature, structure, or characteristic described in connection with the embodiment being included in an embodiment of the disclosure. Thus, appearances of the phrase “in an embodiment”, “in another embodiment” and similar language throughout this disclosure may, but do not necessarily, refer to the same embodiment.

The terms “comprises”, “comprising”, or any other variations thereof, are intended to cover a non-exclusive inclusion, such that a process or method that comprises a list of steps/operations does not include only those steps/operations but may include other steps/operations not expressly listed or inherent to such process or method. Similarly, one or more devices or sub-systems or elements or structures or components preceded by “comprises . . . a” does not, without more constraints, preclude the existence of other devices or other sub-systems or other elements or other structures or other components or additional devices or additional sub-systems or additional elements or additional structures or additional components.

The disclosure provides a system and a method to select a NSSRG group based on an application requirement and provide seamless enhanced user experience in case of multiple NSSRG groups being deployed by the network. Further, the disclosure facilitates UEs to avail different set of network slices when accessing through different network access (3GPP and non-3GPP). Furthermore, the disclosure aims to allow UEs to change the requested NSSAI based on the availability of the local area data network (LADN) services in the network. Additionally, the disclosure is directed towards UEs to avail different set of network slices when accessing the network through different subscriptions, such as SIM1, SIM2 etc. Moreover, the disclosure facilitates allowing UEs to avoid sending frequent change in requested NSSAI based on the allowed NSSRG group.

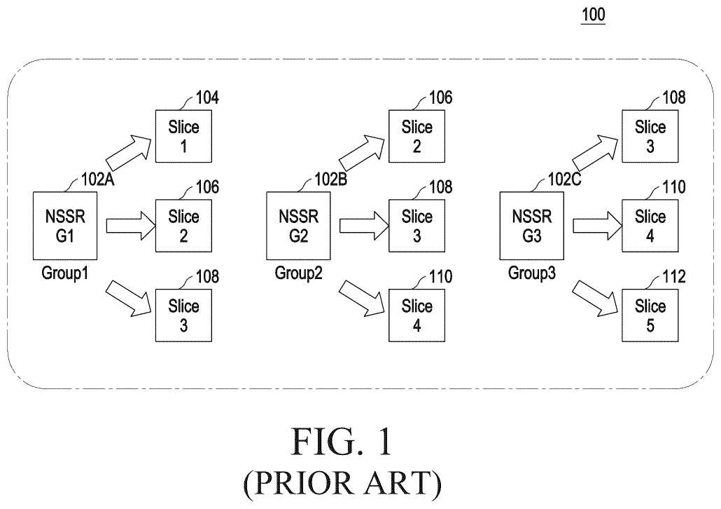

FIG. 1 is a diagram illustrating a plurality of network slice simultaneous registration group (NSSRG) groups 102A, 102B, 102C for the initial registration of a user equipment (UE), according to a prior art technique. In a 5G network, the subscription information for the UE may include, for each S-NSSAI, NSSRG information constraining which S-NSSAIs can be simultaneously provided to the UE in an allowed NSSAI. The subscription information associated with the UE is stored at the UDM. Accordingly, two or more S-NSSAIs sharing at least one NSSRG can be simultaneously included in the allowed NSSAI. Otherwise, these S-NSSAIs cannot be included simultaneously in the allowed NSSAI. The allowed list is shared by access management function (AMF) towards the UE during registration accept message. Initially, the UE may not have the NSSRG information and may include all the S-NSSAIs while sending a registration request during the registration procedure.

For instance, the UE may include all S-NSSAIs, e.g., slices 104, 106, 108, 110, 112 while sending the registration request during the initial registration procedure with the network (e.g., 5G network). Since, the network can send slices belonging to a common NSSRG group 102A, 102B, 102C in the allowed list, either of the below can be provided based on default configured slices for the UE, for example, (a) slices 1, 2, and 3; or (b) slices 2, 3, and 4, or (c) slices 3, 4, and 5, but it is not possible to receive all the 5 slices. From next time onwards, the UE may request only for the slices that were received in the allowed list. This will restrict the UE to request for any other slice, which is not a part of the same NSSRG groups 102A, 102B, 102C.

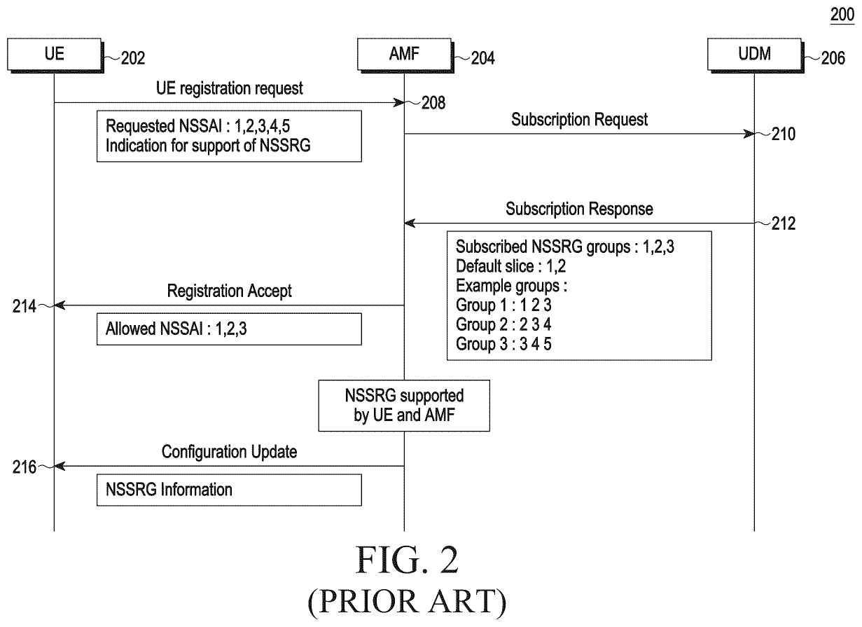

FIG. 2 is a signal flow diagram illustrating a process flow 200 depicting the initial registration procedure when the UE 202 does not have NSSRG information, according to a prior art technique. In the an example scenario, the UE 202 may initiate a registration procedure with the AMF 204 of 5G network, wherein the UDM 206 may be configured to store subscription data of the UE 202. The UE 202 may not possess the NSSRG information during initiation of the registration procedure.

Thus, as depicted, at operation 208, the UE 202 may include all the S-NSSAI slices 1-5 in the registration request. Further, the UE 202 may also indicate NSSRG support through the registration request 208. At operation 210, the AMF, upon receiving the registration request, may verify subscription information associated with the UE 202 with the UDM 206. At operation 212, the UDM 206 may send a subscription response message which includes all the subscribed NSSRG groups along with S-NSSAI in the allowed list that belongs to the same NSSRG group. Further, at operation 214, a registration accept message may be transmitted by the AMF 204 to the UE 202. The registration accept message may indicate the NSSRG group along with S-NSSAI which is allowed to the UE based on the registration request. The AMF 204 may determine the NSSRG supported by the UE 202 and the AMF 204. At operation 216, the NSSRG information will be provided to the UE 202 by the AMF 204 via the configuration update procedure.

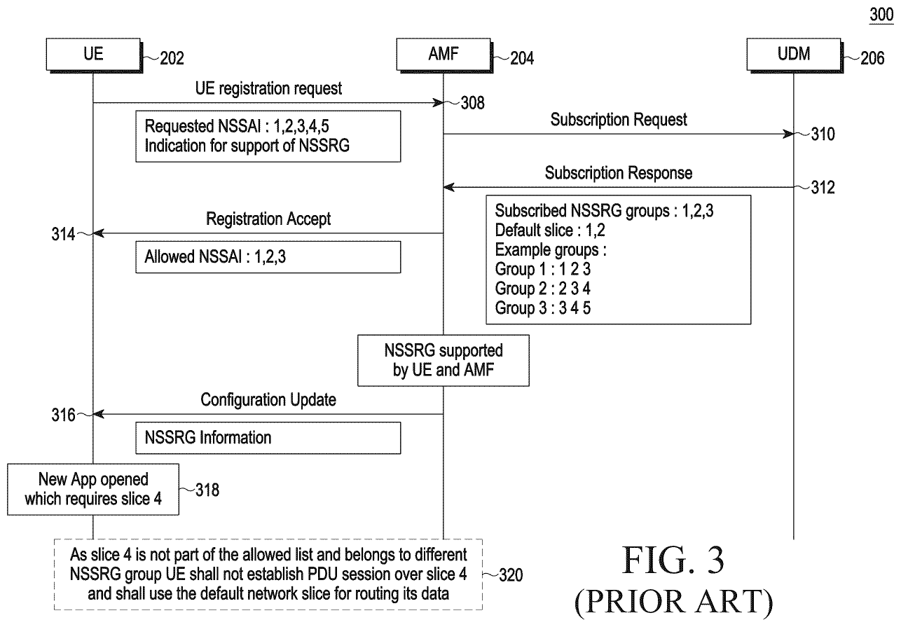

FIG. 3 is a signal flow diagram illustrating a process flow 300 depicting a first problem when the UE 202 is unable to use a network slice belonging to different NSSRG groups, according to the prior art. The first problem being referred to here, is described in conjunction with NSSRG groups 102A, 102B, 102C and slices 104, 106, 108, 110, 112, as shown in FIG. 1. Thus, for the sake of brevity, the NSSRG groups 102A, 102B, 102C are not discussed in detail here again. Further, the operations 308, 310, 312, 314, 316 followed for the initial registration procedure as depicted are the same as or similar to operations 208, 210, 212, 214, 216 as discussed in conjunction with FIG. 2, and hence, may not be discussed in detail again for the sake of brevity.

As depicted, once the registration is successful, the AMF 204 of the network may share, with the UE 202, the allowed network slices through the registration accept message at operation 314, and also share the NSSRG configuration information through the configuration update message at operation 316. In this illustrated example, the AMF 204 of the network may provide allowed slices, 1, 2, 3 belonging to NSSRG group 1 to the UE. However, if at operation 318, a user opens an application on the UE 202, which is mapped to network slice 4 (belonging to NSSRG group 2) through the URSP rule table, it is not possible for the UE 202 to send a packet data unit (PDU) session request over slice 4 as it is not a part of the allowed NSSAI list. The UE 202 may map the user data, for the application requiring slice 4, through a default network slice for routing of data as shown at operation 320, which may degrade the experience of the user.

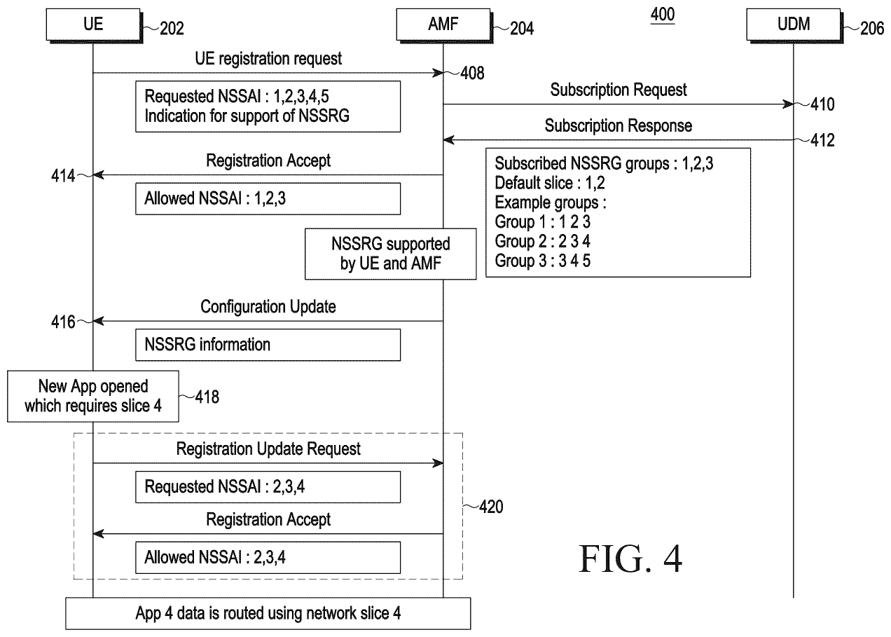

FIG. 4 is a signal flow diagram illustrating an example process flow 400 addressing the first problem illustrated in FIG. 3, by changing the NSSRG group by sending a registration update request to include a new requested NSSAI list, according to various embodiments.

The first problem being referred to here, is described in conjunction with NSSRG groups 102A, 102B, 102C and slices 104, 106, 108, 110, 112 as shown in FIG. 1. Thus, for the sake of brevity, the NSSRG groups 102A, 102B, 102C may not be discussed in detail here. Further, the operations 408, 410, 412, 414, 416, 418 followed for the initial registration procedure as depicted, are the same as or similar to operations 208, 210, 212, 214, 216 and operation 318 respectively previously discussed in conjunction with FIGS. 2 and 3, and hence, may not be discussed in detail here for the sake of brevity.

At operation 418, as the slice that is required to be used is not a part of the same NSSRG group, the UE 202 cannot establish a PDU session over that slice. Thus, the UE 202 may identify that the required network slice 4 is not a part of the same NSSRG group (e.g., allowed NSSRG group 1). Accordingly, the UE 202 may evaluate all the applications currently under use and determine a need for change in the set of slices of the NSSRG group 1. At operation 420, upon identifying that there is a need to change the NSSRG group, the UE 202 may initiate a registration update request with one or more sets of slices (e.g., slices 2, 3, 4) in the requested S-NSSAI to be set to the new identified NSSRG group. Accordingly, the new application data may then be transmitted over network slice 4, which enhances the user experience.

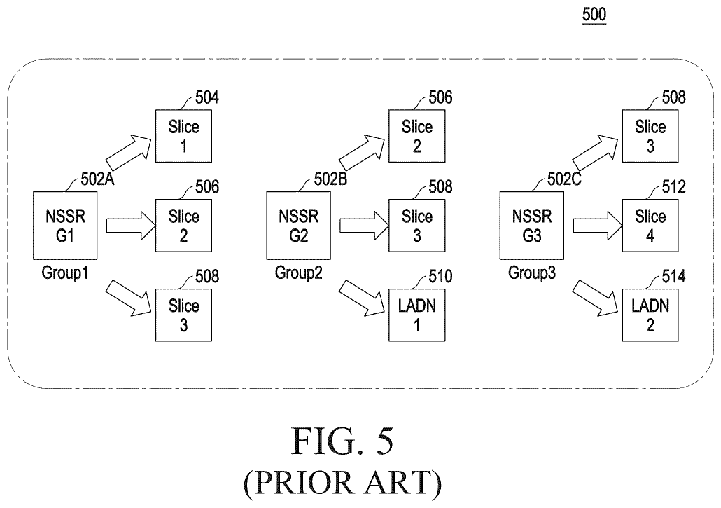

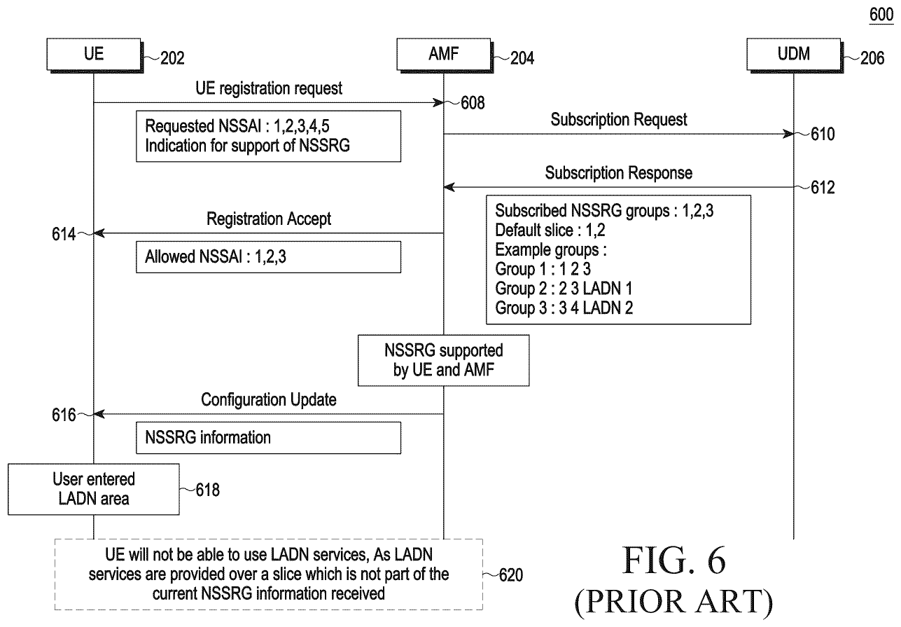

FIG. 5 is a block diagram 500 illustrating a second problem associated with the detection of ultra-reliable and low-latency communications (URLLC) or local area data network (LADN) area and the need for using a different NSSRG, according to a prior art technique. FIG. 6 is a signal flow diagram illustrating a process flow 600 depicting a second problem associated with the UE 202 being unable to use URLLC/LADN services over different NSSRG, according to a prior art technique. FIGS. 5 and 6 are discussed in conjunction with each other for ease of explanation.

The second problem being referred to here, is described in conjunction with NSSRG groups 502A, 502B, 502C and slices/LADNs 504, 506, 508, 510, 512, 514. Since NSSRG groups 502A, 502B, 502C are similar to 102A, 102B, 102C, for the sake of brevity, the NSSRG groups 502A, 502B, 502C may not discussed in detail here. Further, the operations 608, 610, 612, 614, 616 followed for the initial registration procedure as depicted, are the same as or similar to operations 208, 210, 212, 214, 216 previously discussed in conjunction with FIG. 2, and hence, may not be discussed in detail here for the sake of brevity.

After the initial registration is successful, the AMF 204 of the network shares the allowed network slices via the registration accept message 214, and also the NSSRG configuration information through the configuration update message 21. At operation 618, a user of the UE 202 may enter an area, where the LADN PDU session needs to be enabled as per the URSP rule table. Further, as depicted at operation 620, it may not be possible for the UE 202 to send a PDU session request over the LADN slice, as it is not part of the allowed NSSAI list and NSSRG information. Thus, the UE 202 will not be able to use LADN services though the UE 202 has a subscription available to use the LADN services. Similarly, the user may enter an area where URLLC s-NSSAI is available as per the location information configured in the URSP table. But since the UE 202 is currently registered with an NSSRG group, where URLLC is not a part of the allowed list, the UE 202 will be unable to use URLLC services.

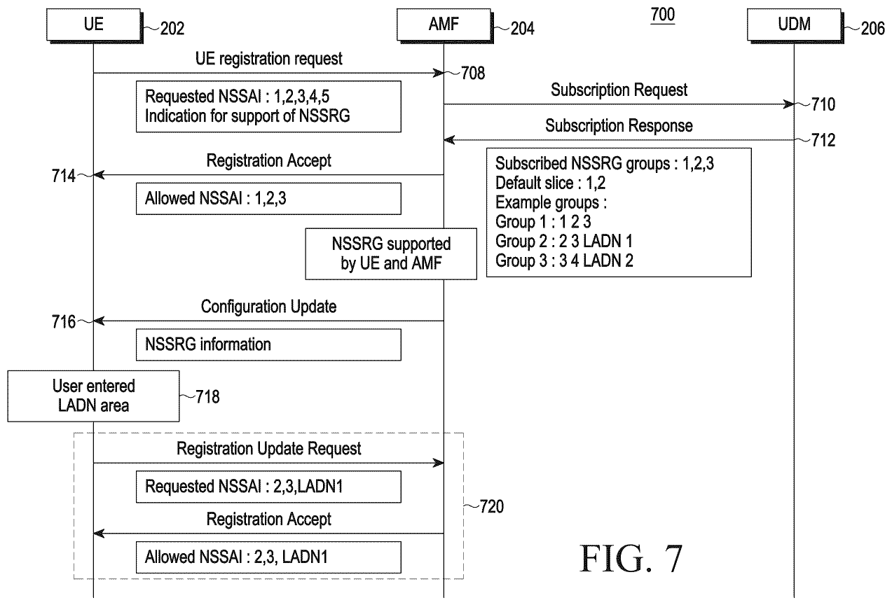

FIG. 7 is a signal flow diagram illustrating an example process flow 700 addressing the second problem illustrated in FIGS. 5 and 6 by changing the NSSRG group by sending a registration update request to include new LADN NSSAI in the requested NSAAI list, according to various embodiments.

The second problem being referred to here, is described in conjunction with NSSRG groups 502A. 502B, 502C and slices/LADNs 502, 504, 506, 508, 510, 512, 514 as shown in FIG. 5. Thus, for the sake of brevity, the NSSRG groups 502A, 502B, 502C may not be discussed in detail here. Further, the operations 708, 710, 712, 714, 716, 718 followed for the initial registration procedure as depicted, are the same as or similar to operations 208, 210, 212, 214, 216 and operation 618 respectively previously discussed in conjunction with FIGS. 2 and 6, and hence, may not be discussed in detail here for the sake of brevity.

As depicted, at operation 718, the user may enter an LADN area. The UE 202 may evaluate the URSP rules and may find that an LADN slice is supported in the registration area. However, the UE 202 may determine that the LADN slice may belong to NSSRG Group 2, which may not be a part of UE allowed network slices of NSSRG Group 1. Thus, the UE 202 cannot establish a PDU session over that LADN slice. Subsequently, the UE 202, after operation 718, may evaluate all the applications currently under use and evaluate a need for change in the set of slices of the NSSRG group. At operation 720, upon identifying that there is a need for a change of the NSSRG group, the UE 202 may initiate a mobility registration update request with a set of slices including the LADN service slice in the requested NSSAI. In response, at operation 720, the AMF 204 may accept a new registration request and may provide a registration accept message including the allowed NSSAI or updated network slices (e.g., slice 2, 3, and LADN 1), which comprises the LADN slice. Thus, the user may use the LADN slice after operation 720 to access the LADN services, which may enhance the user experience.

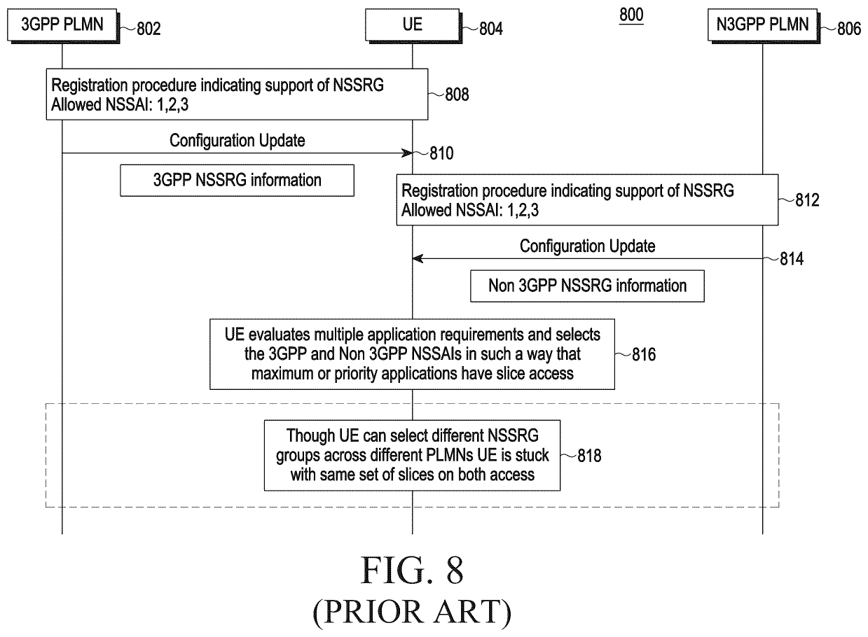

FIG. 8 is a signal flow diagram 800 depicting a third problem associated with an allocation of the same network slices for a UE 804 from two different access networks, according to a prior art technique. As depicted, the UE 804 may be registered over both a 3GPP access network and a non-3GPP access network 806 at the same time over two different PLMNs 802 and 806, respectively. Due to registration with two different network accesses, it is possible that the UE 804 may request and also, the network PLMNs 802 and 806 provide the same set of slices on both the access. The registration and configuration update procedure with the 3GPP PLMN 802 is provided in operations 808, 810, while the registration and configuration update procedure with the non-3GPP PLMN 806 is provided in operations 812 and 814. The description related to operations associated with the registration and configuration update procedure may not be discussed in detail here since similar operations have been previously discussed in conjunction with at least FIG. 2 above.

At operation 816, the UE 804 may evaluate multiple application requirements and may select the 3GPP and non-3GPP NSSAIs in such a way that maximum or priority applications have slice access. However, as depicted at operation 818, if any new application is opened by the user at the UE 804 which requires a slice that is not provided in either network, the UE data associated with the application will be routed over the default network slice with reduced data capacities, which may again degrade the user experience.

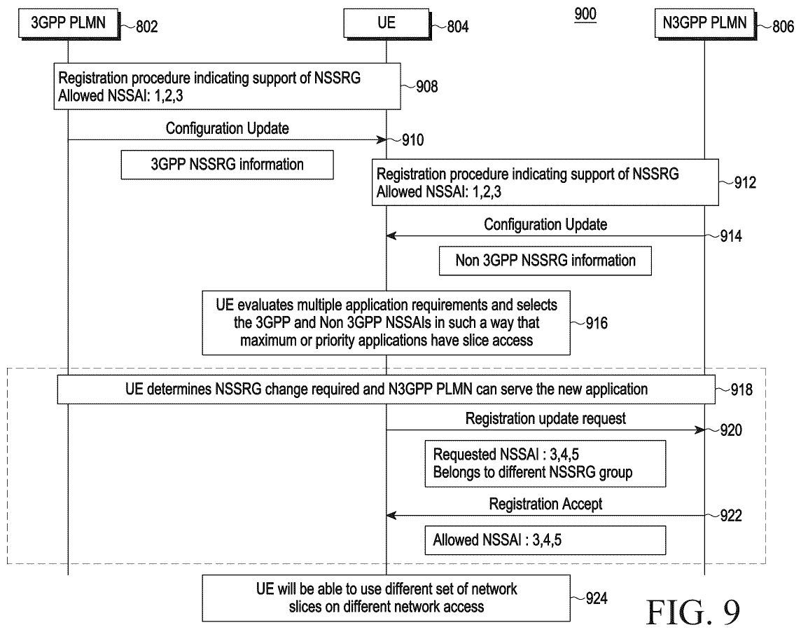

FIG. 9 is a signal flow diagram illustrating an example process flow addressing the third problem illustrated in FIG. 8, by selecting slices belonging to different NSSRG groups when registering on two different network access, according to various embodiments.

The third problem being referred to here, is described in conjunction with FIG. 8, and further, the operations 908, 910, 912, 914, 916 followed for the initial registration, configuration update, and UE evaluation procedure as depicted, are the same as or similar to operations 808, 810, 812, 814, 816 previously discussed in conjunction with FIG. 8, and hence, may not be discussed in detail here for the sake of brevity.

Thus, the UE 804 registers with different PLMNs 802 and 806 over 3GPP and non-3GPP systems respectively to receive the NSSRG information. In an example embodiment, the allowed NSSAI on 3GPP access may include slices 1, 2, and 3 and NSSRG Group 1. Similarly, the allowed NSSAI on non-3GPP access may also include slices 1, 2, and 3 and NSSRG Group 1.

At operation 918, based on the received information, the UE 804 may evaluate the applications currently being used on the device as depicted. The user may open an application which requires a slice of NSSRG2, which is not in the allowed list. For example, the UE 804 may evaluate the URSP policies on both the access, and may determine a requirement of NSSRG change, and non-3GPP PLMN 806 can serve the new application. At operation 920, based on the NSSRG information and UE usage requirement, the UE 804 may initiate the registration update request message with updated information on requested NSSAIs in both the access. For instance, the UE 804 may send a mobility registration request to a network on one of the network access, with a change in requested network slices (e.g., slices 2, 3, 4 of NSSRG2). At operation 922, the network may accept a new registration request and the UE 804 may receive a registration accept message with allowed NSSAI as slices 2, 3, and 4. Accordingly, based on the received registration accept message, the UE will be able to use different sets of network slices on different network access at operation 924.

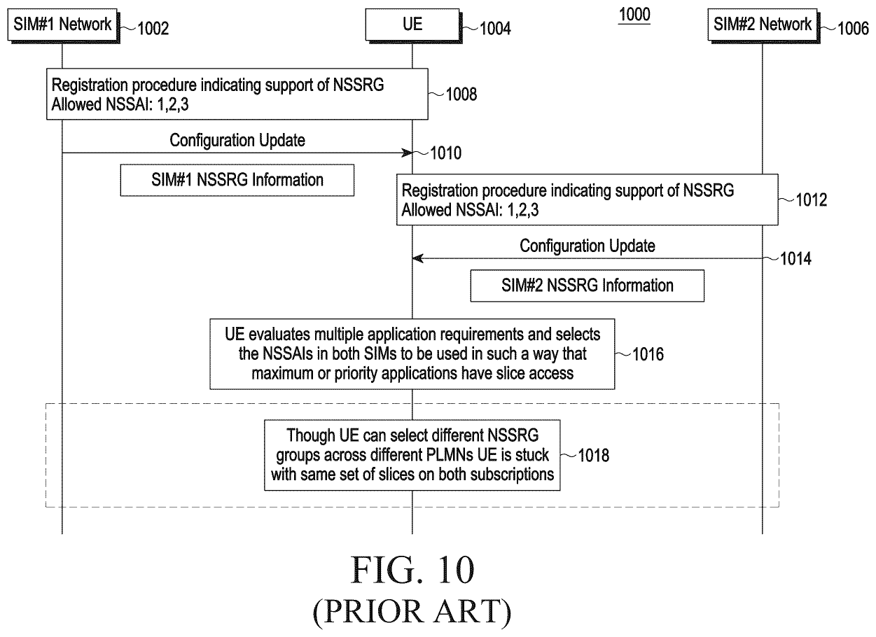

FIG. 10 is a signal flow diagram illustrating a process flow 1000 depicting a fourth problem associated with allocation of same network slices from two different subscriptions, according to a prior art technique. As depicted, the UE 1004 may be registered over two subscriptions, e.g., a subscriber identify module (SIM) 1 network 1002 and a SIM2 network 1006 at the same time. The registration and configuration update procedure with the SIM1 network 1002 is provided in operations 1008, 1010, while the registration and configuration update procedure with the SIM2 network 1006 is provided in operations 1012 and 1014. The description related to operations associated with registration and configuration update procedure is may not be discussed in detail here since similar operations have been previously discussed in conjunction with at least FIG. 2 above. The SIM1 NSSRG information and SIM2 NSSRG information may be provided by the respective networks 1002 and 1006.

At operation 1016, the UE 1004 may evaluate multiple application requirements and may select the NSSAIs in both SIMs in such a way that maximum or priority applications have slice access. However, as depicted at operation 1018, though the UE 1004 may select different NSSRG groups across different PLMNs, but the UE is stuck with the same set of slices on both subscriptions, which may again degrade the user experience.

When the UE 1004 has registered over both SIM subscriptions and each subscription supports a different set of slices per group as configured at network side, there is no mechanism defined on how the requested NSSAI can be included by the UE 1004, so that the UE 1004 may get all the required services at any instance. Thus, it may be possible that the UE 1004 receives same NSSRG groups from both networks, and hence same set of network slices can be utilized. Further, if any new application opened by a user requires a slice that is not provided in either of networks, the UE data is routed over default network slice with reduced data capacities, thereby degrading user experience.

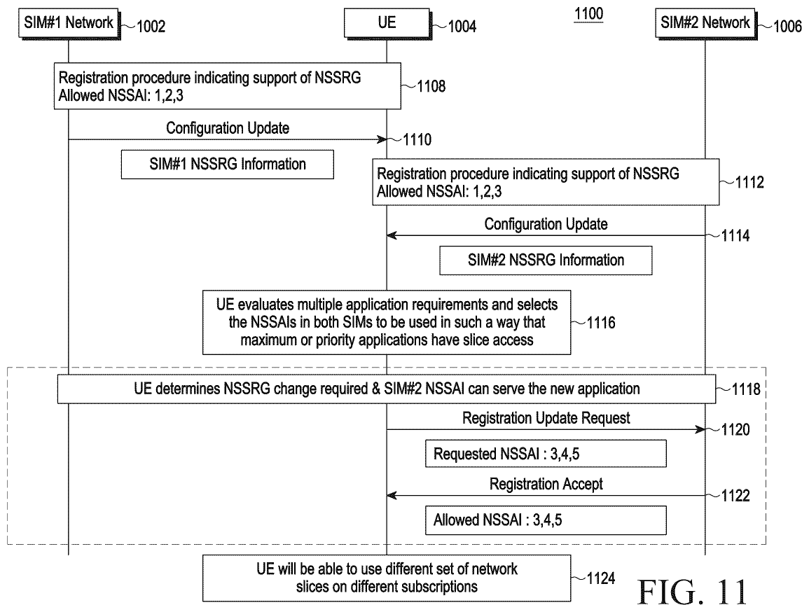

FIG. 11 is a signal flow diagram illustrating an example process addressing the fourth problem illustrated in FIG. 10, by selecting slices belonging to different NSSRG groups when registering on two different networks, according to various embodiments.

The fourth problem being referred to here, is described in conjunction with FIG. 10, and further, the operations 1108, 1110, 1112, 1114, 1116 followed for the initial registration, configuration update, and UE evaluation procedure as depicted, are the same as or similar to operations 1008, 1010, 1012, 1014, 1016 previously discussed in conjunction with FIG. 10, and hence, may not be discussed in detail here for the sake of brevity.

Thus, the UE 1004 registers with different networks/subscriptions 1002 and 1006 to receive the NSSRG information. In an example embodiment, the allowed NSSAI on SIM1 subscription may include slices 1, 2, and 3 and NSSRG Group 1. Similarly, the allowed NSSAI on SIM2 subscription may also include slices 1, 2, and 3 and NSSRG Group 1.

At operation 1118, the UE 1004 may evaluate the applications currently being used on the device as depicted. The user may open an application which requires a slice of NSSRG2, which is not in the allowed list. Specifically, the UE 1004 may evaluate the URSP policies on both the SIM networks, and may determine a requirement of NSSRG change, and SIM2 1006 NSSAI can serve the new application. At operation 1120, based on the NSSRG information and UE usage requirement, the UE 1004 may initiate the registration update request message with updated information on requested NSSAIs on the selected subscription. At operation 1122, the network may accept new registration request and the UE 1004 may receive a registration accept message with allowed NSSAI as slices 3, 4, and 5. Accordingly, based on the received registration accept message, the UE 1004 will be able to use different set of network slices on different network access at operation 1124.

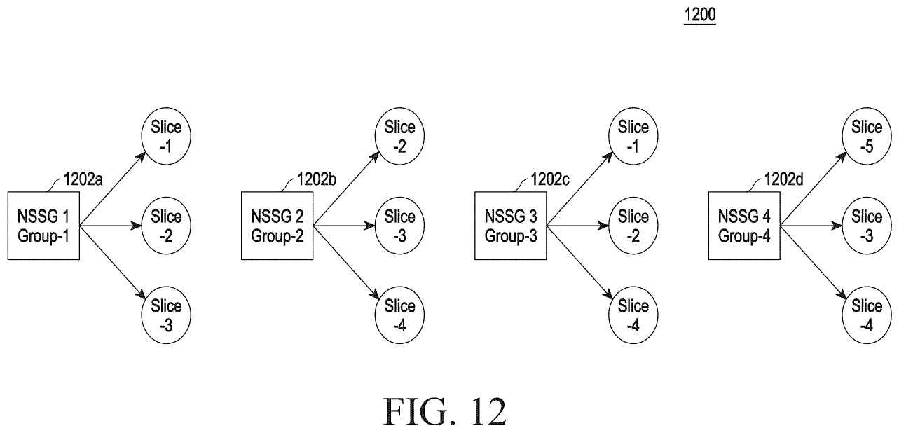

FIG. 12 is a diagram illustrating a plurality of NSSRG groups 1202a, 1202b, 1202c, 1202d for the initial registration of the UE, according to various embodiments. Considering a UE assigned with slices from NSSRG group 1 1202, e.g., slice-1, slice-2 and slice-3; each slice being assigned with one (different) application. At any specific time-stamp, if the application is triggered, it is counted as 1, otherwise 0. The conditions that may be considered for setting the count to 1 may include, time duration of the application used, and quality of service (QoS) that is being used by the application (such as data rate). This is also illustrated in Table 1 below:

TABLE 1

| | Slice-1 | Slice-2 | Slice-3 | Slice-4 | Slice-5 |
|---|---|---|---|---|---|
| | (Usage | (Usage | (Usage | (Usage | (Usage |
| Time | probability of | probability of | probability of | probability of | probability of |
| Stamp | Application-1) | Application-2) | Appplication-3) | Appplication-4) | Appplication-5) |
| Time-1 | 0 | 1 | 0 | 0 | 1 |
| Time-2 | 1 | 1 | 1 | 1 | 0 |
| . . . | 1 | | | 1 | 0 |
| Time-n | 1 | 0 | 1 | 1 | 0 |
| Average Time | W1 = 0.20 | W2 = 0.28 | W3 = 0.11 | W4 = 0.31 | W5 = 0.10 |
| (probability of | | | | | |
| occurrence) | | | | | |

To find the probability distribution of the occurrence of the application in any specific slice (Slice-1, Slice-2, . . . . Slice-N), the application may be modeled to compute an expected reward can also be called an action-value function as per equation 1 below:

$$Q ( a ) = 𝔼 [ r \vert a ] \qquad ( 1 )$$

It is represented by q(a) and defines the average reward for each action at a time t with action a. The action values for each action is given for each time step as per equation 2 below:

$${Q}_{t} ( a ) = \frac{{\sum }_{i = 1}^{t} {1}_{( {a}_{t} = a )} \cdot {R}_{i}}{{\sum }_{i = 1}^{t} {1}_{( {a}_{t} = a )}} \qquad ( 2 )$$

Here, an action-value function “Q(a)” is defined with respect to a time stamp “t” for which each time stamp a reward function is generated for each slice and summing up all the reward functions for an action taken for all the slice considered in the reinforcement learning model.

Further, the action may be modeled, as the occurrence of application in each slice (as given in the table) as distribution function at time step that maximises the above expression, given by equation 3 below:

$$arg {max}_{a} {Q}_{t} ( a ) \qquad ( 3 )$$

Further, to decide which slice needs to be used and further utilized, a user defined threshold value (thd) may be mapped, say 0.5, as a probability distribution, where the output of the occurrence of the distribution of the application (as weightage or weight wi) are checked:

If the Wi is >=thd, then the slice will be further mapped to another group of slice/further mapped (e.g., group-2, etc.)

If the Wi is <=thd, it can be used a default slice in present group (e.g., group-1) Based on the usage of application, it can be decided whether to use default slice in a NSSG group or can be mapped to another slice of different NSSG group.

Here, the threshold value has been defined by user. The threshold value 0.5 indicate equal probability distribution, based on weighted value of the application. The threshold value may be used to decide whether to use default slice or map to another slice of different NSSG group.

In the example illustrated in FIG. 12, currently NSSRG group1 1202a is in use and if a user has opened new application as 4:
The UE may check if any associated URSP rule for application 4 to establish a PDU over an existing or new slice.
UE may further check if the slice can be established as part of same NSSRG or not.
As per learnt model mentioned above, the UE may further identify whether there is a need to change NSSRG 1 group to another group.
As per the prediction model, the UE may change the NSSRG group to new group 3.
The new NSSRG group is selected based on the average weights associated with each application; and by satisfying the max weighted average value in the order of the applications.

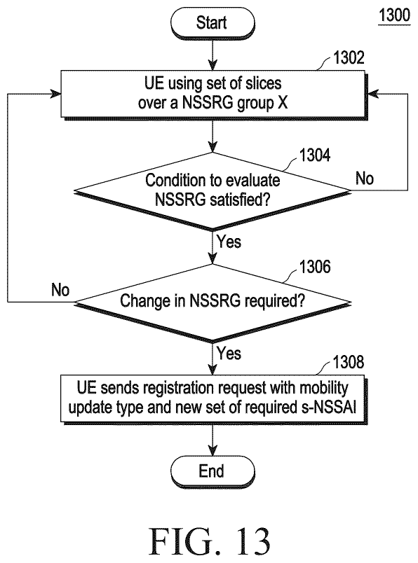

FIG. 13 is a flowchart illustrating an example method 1300 for determining whether a change of NSSRG is required, according to various embodiments.

At operation 1302, the method 1300 may include a UE using set of slices over a NSSRG group X.

At operation 1304, the method 1300 may include determining whether trigger conditions to evaluate NSSRG are satisfied. In an embodiment, the trigger conditions may include one or more of a new application opened by user, the UE receiving configuration update command with change is supported slices, the UE receiving configuration update command with change in NSSRG information, the UE entering a new LADN area, and the UE registering over another access in same or different PLMN.

At operation 1306, the method 1300 may include determining whether a change in NSSRG is required. A change in NSSRG may be required based, for example, and without limitation, on one or more of:
a) the new application opened by user requires a slice from a different NSSRG group;
b) the new application opened by user has a computed average weightage more or equal to current applications under use;
c) the UE may enter an LADN area, URSP has a slice defined for LADN but not part of current NSSRG in use;
d) the UE is registered on different access than the current access (3GPP/N3GPP) and both supports different set of slices; and
   the UE is registered over another access in different PLMN and supported slices are different; Further, it may be determined that no change in NSSRG is required based on one or more of:
a) the new application opened by user does not have any slice configured in URSP or it is already part of the existing allowed NSSAI list;
b) the average weight computed from learning model for the application is lesser as compared to other applications in use;
c) QoS used by the new application does not require stringent QoS requirements as per learnt model.
d) The S-NSSAI required for the new application is not supported in current cell/tracking area (TA)/registration area (RA)/PLMN as per the partially(partly) Allowed NSSAI information or partly rejected NSSAI information or network slice area of service information (NS-AoS) or S-NSSAI location availability Information.

At operation 1308, the method 1300 may include the UE sending a registration request with mobility update type and new set of required s-NSSAI.

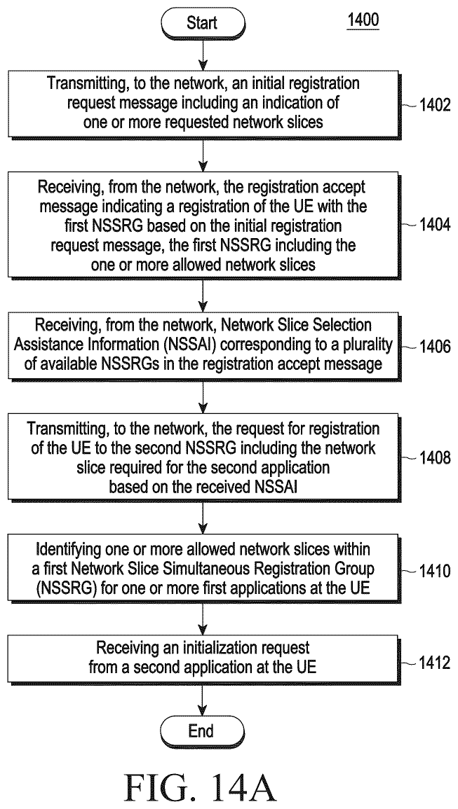

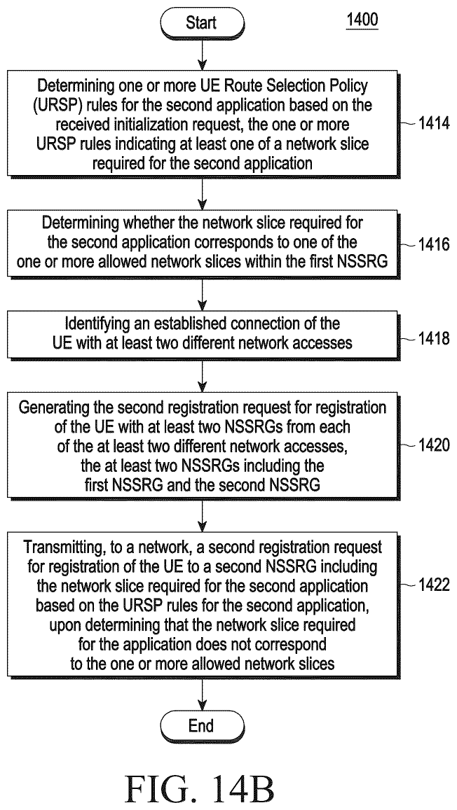

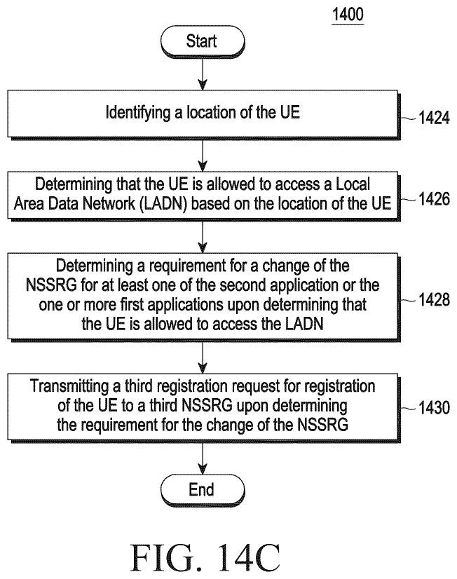

FIGS. 14A, 14B and 14C are flowcharts illustrating an example method 1400 for performing network slice reselection by a user equipment (UE), according to various embodiments.

At operation 1402, the method 1400 comprises transmitting, to the network, an initial registration request message including an indication of one or more requested network slices.

At operation 1404, the method 1400 comprises receiving, from the network, the registration accept message indicating a registration of the UE with the first NSSRG based on the initial registration request message, the first NSSRG including the one or more allowed network slices.

At operation 1406, the method 1400 comprises receiving, from the network, Network Slice Selection Assistance Information (NSSAI) corresponding to a plurality of available NSSRGs in the registration accept message.

At operation 1408, the method 1400 comprises transmitting, to the network, the request for registration of the UE to the second NSSRG including the network slice required for the second application based on the received NSSAI.

At operation 1410, the method 1400 comprises identifying one or more allowed network slices within a first Network Slice Simultaneous Registration Group (NSSRG) for one or more first applications at the UE.

At operation 1412, the method 1400 comprises receiving an initialization request from a second application at the UE.

At operation 1414, the method 1400 comprises determining one or more UE Route Selection Policy (URSP) rules for the second application based on the received initialization request, the one or more URSP rules indicating at least one of a network slice required for the second application.

At operation 1416, the method 1400 comprises determining whether the network slice required for the second application corresponds to one of the one or more allowed network slices within the first NSSRG.

At operation 1418, the method 1400 comprises identifying an established connection of the UE with at least two different network accesses.

At operation 1420, the method 1400 comprises generating the second registration request for registration of the UE with at least two NSSRGs from each of the at least two different network accesses, the at least two NSSRGs including the first NSSRG and the second NSSRG.

At operation 1422, the method 1400 comprises transmitting, to a network, a second registration request for registration of the UE to a second NSSRG including the network slice required for the second application based on the URSP rules for the second application, upon determining that the network slice required for the application does not correspond to the one or more allowed network slices.

At operation 1424, the method 1400 comprises identifying a location of the UE.

At operation 1426, the method 1400 comprises determining that the UE is allowed to access a local area data network (LADN) based on the location of the UE.

At operation 1428, the method 1400 comprises determining a requirement for a change of the NSSRG for at least one of the second application or the one or more first applications upon determining that the UE is allowed to access the LADN.

At operation 1430, the method 1400 comprises transmitting a third registration request for registration of the UE to a third NSSRG upon determining the requirement for the change of the NSSRG.

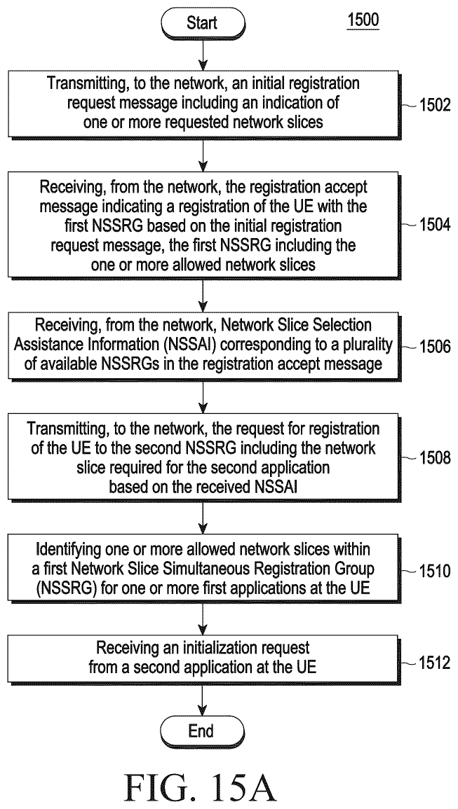

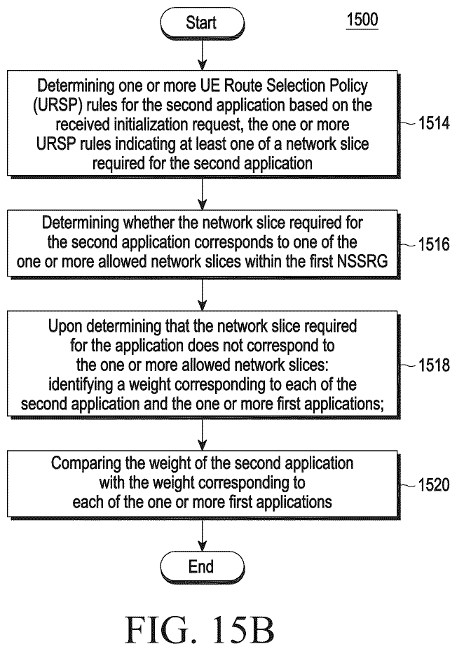

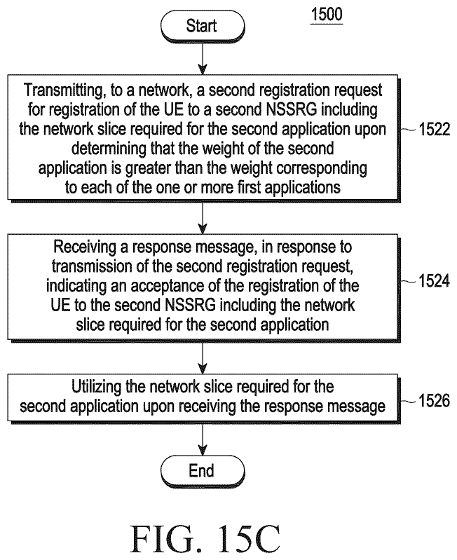

FIGS. 15A, 15B and 15C are flowcharts illustrating an example method 1500 for performing network slice reselection by the UE, according to various embodiments. The operations 1502, 1504, 1506, 1508, 1510, 1512, 1514 and 1516 are similar to operations 1402, 1404, 1406, 1408, 1410, 1412, 1412 and 1416, the description of these operations may not be repeated here for the sake of brevity.

At operation 1518, the method 1500 comprises identifying a weight corresponding to each of the second application and the one or more first applications upon determining that the network slice required for the application does not correspond to the one or more allowed network slices. The method 1500 also includes determining at least one of an actual usage or a probability of the usage of each of the second application and the one or more first applications within a specified period of time. Further, the method 1500 includes generating the weight corresponding each of the second application and the one or more first applications based on determined at least one of the actual usage or the probability of the usage of each of the second application and the one or more first applications, respectively.

At operation 1520, the method 1500 comprises comparing the weight of the second application with the weight corresponding to each of the one or more first applications.

At operation 1522, the method 1500 comprises transmitting, to a network, a second registration request for registration of the UE to a second NSSRG including the network slice required for the second application upon determining that the weight of the second application is greater than the weight corresponding to each of the one or more first applications.

At operation 1524, the method 1500 comprises receiving a response message, in response to transmission of the second registration request, indicating an acceptance of the registration of the UE to the second NSSRG including the network slice required for the second application.

At operation 1526, the method 1500 comprises utilizing the network slice required for the second application upon receiving the response message.

While the above operations are shown in FIGS. 14 and 15 and described in a particular sequence, the operations may occur in variations to the shown sequence by omitting some operations, or changing sequence of some operations in accordance with various embodiments of the disclosure.

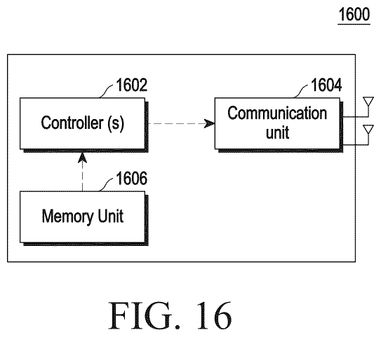

FIG. 16 is a block diagram illustrating an example configuration of a user equipment (UE) 1600 in a wireless communication system, according to various embodiments. The configuration of FIG. 16 may be understood as a part of the configuration of the UE as discussed throughout this disclosure. Hereinafter, it is understood that terms including “unit” or “module” may refer to the unit for processing at least one function or operation and may be implemented in hardware, software, or a combination of hardware and software.

Referring to FIG. 16, the UE 1600 may correspond to a system 1600 comprising at least one controller or processor (e.g., including various control and/or processing circuitry) 1602, a communication unit (e.g., including communication circuitry) 1604 (e.g., communicator or communication interface), and a memory unit (e.g., including a memory) 1606 (e.g., storage). By way of example, the UE 1600 may be a User Equipment, such as a cellular phone or other device that communicates over a plurality of cellular networks (such as a 3G, 4G, a 5G or pre-5G, 6G network or any wireless communication network such as 802.11 based Wi-Fi networks). The communication unit 1604 may include various communication circuitry and perform functions for transmitting and receiving signals via a wireless channel.

As an example, the controller 1602 may include various processing and/or control circuitry. For example, as used herein, including the claims, the terms “processor” and/or “controller” may include various processing and/or control circuitry, including at least one processor, wherein one or more of at least one processor may be configured to perform various functions described herein. Additionally, the at least one processor may include a combination of processors and/or controllers performing various of the recited/disclosed functions. At least one processor and/or controller may execute program instructions to achieve or perform various functions. The controller 1602 be include a single processing unit or a number of units, all of which could include multiple computing units. The controller 1602 may be implemented as one or more microprocessors, microcomputers, microcontrollers, digital signal processors, central processing units, state machines, logic circuitries, and/or any devices that manipulate signals based on operational instructions. Among other capabilities, the controller 1602 is configured to fetch and execute computer-readable instructions and data stored in the memory. The controller 1602 may include one or a plurality of processors. One or a plurality of controller 1602 may include a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of controllers 1602 may control the processing of the input data in accordance with a predefined (e.g., specified) operating rule or artificial intelligence (AI) model stored in the non-volatile memory and the volatile memory, e.g., memory unit 1606. The predefined operating rule or artificial intelligence model is provided through training or learning.

The memory unit 1606 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes. The controller 1602 may include one or more modules which are configured to perform one or more functions discussed herein, such as for performing network slice reselection by a User Equipment.

In an embodiment, the model 1200 explained with reference to FIG. 12 may be stored on UE 1600. Specifically, the memory unit 1606 may store the model 1200. Further, the model 1200 may be unique to each UE 1600 based at least on usage information, location, time of the UE 1600.

At least by virtue of aforesaid, the disclosure provides various advantages, including the following advantages. For instance, the disclosure provides a methodology to prioritize and select the NSSRG group based on the application in use by user and also based on location, and the UEs select requested S-NSSAI from one of the prioritized/identified NSSRG groups. Additionally, the disclosure provides a mechanism on how UEs select a correct NSSRG group based on the usage of the user and applications that are being used.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for performing network slice reselection by a user equipment (UE), the method comprising:
identifying one or more allowed network slices within a first network slice simultaneous registration group (NSSRG) for one or more first applications at the UE;
receiving an initialization request from a second application at the UE;
determining one or more route selection policy (URSP) rules for the second application based on the received initialization request, the one or more URSP rules indicating at least one network slice required for the second application;
determining whether the at least one network slice required for the second application corresponds to one of the one or more allowed network slices within the first NSSRG; and
transmitting, to a network, a second registration request for registration of the UE to a second NSSRG including the at least one network slice required for the second application based on the URSP rules for the second application, based on determining that the at least one network slice required for the second application does not correspond to the one or more allowed network slices.

2. The method of claim 1, comprising:
receiving a response message, in response to transmission of the second registration request, indicating an acceptance of the registration of the UE to the second NSSRG including the at least one network slice required for the second application; and
utilizing the at least one network slice required for the second application based on receiving the response message.

3. The method of claim 1, wherein prior to identifying the one or more allowed network slices within the first NSSRG, the method comprises:
transmitting, to the network, an initial registration request message including an indication of one or more requested network slices;
receiving, from the network, a registration accept message indicating a registration of the UE with the first NSSRG based on the initial registration request message, the first NSSRG including the one or more allowed network slices;
receiving, from the network, network slice selection assistance information (NSSAI) corresponding to a plurality of available NSSRGs in the registration accept message; and
transmitting, to the network, the second registration request for registration of the UE to the second NSSRG including the at least one network slice required for the second application based on the received NSSAI.

4. The method of claim 1, comprising:
identifying a location of the UE;
determining that the UE is allowed to access a local area data network (LADN) based on the location of the UE;
determining a requirement for a change of the NSSRG for at least one of the second application or the one or more first applications based on determining that the UE is allowed to access the LADN; and
transmitting a third registration request for registration of the UE to a third NSSRG based on determining the requirement for the change of the NSSRG.

5. The method of claim 1, comprising:
prior to transmitting the second registration request for registration of the UE to the second NSSRG, identifying an established connection of the UE with at least two different network accesses; and
generating the second registration request for registration of the UE with at least two NSSRGs from each of the at least two different network accesses, the at least two NSSRGs including the first NSSRG and the second NSSRG.

6. The method of claim 1, comprising:
prior to transmitting the second registration request for registration of the UE to the second NSSRG, identifying an established connection of the UE with at least two different public land mobile networks (PLMNs) from two different subscriptions; and
generating the second registration request for registration of the UE with at least two NSSRGs based on each of the at least two different subscriptions, the at least two NSSRGs including the first NSSRG and the second NSSRG.

7. A method for performing network slice reselection by a user equipment (UE), the method comprising:
identifying one or more allowed network slices within a first network slice simultaneous registration group (NSSRG) for one or more first applications at the UE;
receiving an initialization request from a second application at the UE;
determining one or more route selection policy (URSP) rules for the second application based on the received initialization request, the one or more URSP rules indicating at least one network slice required for the second application;
determining whether the at least one network slice required for the second application corresponds to one of the one or more allowed network slices within the first NSSRG; and
based on determining that the at least one network slice required for the second application does not correspond to the one or more allowed network slices:
identifying a weight corresponding to each of the second application and the one or more first applications;
comparing the weight corresponding to each of the second application with the weight corresponding to each of the one or more first applications; and
transmitting, to a network, a second registration request for registration of the UE to a second NSSRG including the at least one network slice required for the second application based on determining that the weight corresponding to each of the second application is greater than the weight corresponding to each of the one or more first applications.

8. The method of claim 7, comprising:
receiving a response message, in response to transmission of the second registration request, indicating an acceptance of the registration of the UE to the second NSSRG including the at least one network slice required for the second application; and
utilizing the at least one network slice required for the second application based on receiving the response message.

9. The method of claim 7, wherein prior to identifying the one or more allowed network slices within the first NSSRG, the method comprises:
transmitting, to the network, an initial registration request message including an indication of one or more requested network slices;
receiving, from the network, a registration accept message indicating a registration of the UE with the first NSSRG based on the initial registration request message, the first NSSRG including the one or more allowed network slices;
receiving, from the network, network slice selection assistance information (NSSAI) corresponding to a plurality of available NSSRGs in the registration accept message; and
transmitting, to the network, the second registration request for registration of the UE to the second NSSRG including the at least one network slice required for the second application based on the received NSSAI.

10. The method of claim 7, wherein identifying the weight corresponding to each of the second application and the one or more first applications comprises:
determining at least one of an usage or a probability of the usage of each of the second application and the one or more first applications within a specified period of time; and
generating the weight corresponding each of the second application and the one or more first applications based on the determined at least one of the usage or the probability of the usage of each of the second application and the one or more first applications, respectively.

11. A user equipment (UE) configured to perform network slice reselection, the UE comprising:
a memory storing instructions; and
at least one processor comprising processing circuitry communicably coupled to the memory, wherein the at least one processor is configured to execute the instructions to:
identify one or more allowed network slices within a first network slice simultaneous registration group (NSSRG) for one or more first applications at the UE;
receive an initialization request from a second application at the UE;
determine one or more route selection policy (URSP) rules for the second application based on the received initialization request, the one or more URSP rules indicating at least one network slice required for the second application;
determine whether the at least one network slice required for the second application corresponds to one of the one or more allowed network slices within the first NSSRG; and
transmit, to a network, a second registration request for registration of the UE to a second NSSRG including the at least one network slice required for the second application based on the URSP rules for the second application, based on determining that the at least one network slice required for the second application does not correspond to the one or more allowed network slices.

12. The UE of claim 11, wherein at least one processor is further configured to execute the instructions to:
receive a response message, in response to transmission of the second registration request, indicating an acceptance of the registration of the UE to the second NSSRG including the at least one network slice required for the second application; and
utilize the at least one network slice required for the second application based on receiving the response message.

13. The UE of claim 11, wherein prior to identifying the one or more allowed network slices within the first NSSRG, at least one processor is further configured to execute the instructions to:
transmit, to the network, an initial registration request message including an indication of one or more requested network slices;
receive, from the network, a registration accept message indicating a registration of the UE with the first NSSRG based on the initial registration request message, the first NSSRG including the one or more allowed network slices;
receive, from the network, network slice selection assistance information (NSSAI) corresponding to a plurality of available NSSRGs in the registration accept message; and
transmit, to the network, the second registration request for registration of the UE to the second NSSRG including the at least one network slice required for the second application based on the received NSSAI.

14. The UE of claim 11, wherein at least one processor is further configured to execute the instructions to:
identify a location of the UE;
determine that the UE is allowed to access a local area data network (LADN) based on the location of the UE;
determine a requirement for a change of the NSSRG for at least one of the second application or the one or more first applications based on determining that the UE is allowed to access the LADN; and
transmit a third registration request for registration of the UE to a third NSSRG based on determining the requirement for the change of the NSSRG.

15. The UE of claim 11, wherein at least one processor is further configured to execute the instructions to:
identify an established connection of the UE with at least two different network accesses prior to transmitting the second registration request for registration of the UE to a second NSSRG; and
generate the second registration request for registration of the UE with at least two NSSRGs from each of the at least two different network accesses, the at least two NSSRGs including the first NSSRG and the second NSSRG.

16. The UE of claim 11, wherein at least one processor is further configured to execute the instructions to:
identify an established connection of the UE with at least two different public land mobile networks (PLMNs) from two different subscriptions prior to transmitting the second registration request for registration of the UE to a second NSSRG; and
generate the second registration request for registration of the UE with at least two NSSRGs based on each of the at least two different subscriptions, the at least two NSSRGs including the first NSSRG and the second NSSRG.

17. A user equipment (UE) configured to perform network slice reselection, the UE comprising:
a memory storing instructions; and
at least one processor, comprising processing circuitry, communicably coupled to the memory, wherein the at least one processor is configured to execute the instructions to:
identify one or more allowed network slices within a first network slice simultaneous registration group (NSSRG) for one or more first applications at the UE;
receive an initialization request from a second application at the UE;
determine one or more route selection policy (URSP) rules for the second application based on the received initialization request, the one or more URSP rules indicating at least one network slice required for the second application;
determine whether the at least one network slice required for the second application corresponds to one of the one or more allowed network slices within the first NSSRG; and
based on determining that the at least one network slice required for the second application does not correspond to the one or more allowed network slices:
identify a weight corresponding to each of the second application and the one or more first applications;
compare the weight corresponding to each of the second application with the weight corresponding to each of the one or more first applications; and
transmit, to a network, a second registration request for registration of the UE to a second NSSRG including the at least one network slice required for the second application based on determining that the weight corresponding to each of the second application is greater than the weight corresponding to each of the one or more first applications.

18. The UE of claim 17, wherein at least one processor is further configured to execute the instructions to:
receive a response message, in response to transmission of the second registration request, indicating an acceptance of the registration of the UE to the second NSSRG including the at least one network slice required for the second application; and
utilize the at least one network slice required for the second application based on receiving the response message.

19. The UE of claim 17, wherein prior to identifying the one or more allowed network slices within the first NSSRG, at least one processor is further configured to execute the instructions to:
transmit, to the network, an initial registration request message including an indication of one or more requested network slices; and
receive, from the network, a registration accept message indicating a registration of the UE with the first NSSRG based on the initial registration request message, the first NSSRG including the one or more allowed network slices.

20. The UE of claim 19, wherein at least one processor is further configured to execute the instructions to:
receive, from the network, network slice selection assistance information (NSSAI) corresponding to a plurality of available NSSRGs in the registration accept message; and
transmit, to the network, the second registration request for registration of the UE to the second NSSRG including the at least one network slice required for the second application based on the received NSSAI.
